(19) United States
(12) Patent Application Publication
(10) Pub. No.: US 2023/0325828 A1
(43) Pub. Date: Oct. 12, 2023

(54) Method and Device for Authenticating a Vehicle

(71) Applicant: Bayerische Motoren Werke Aktiengesellschaft, Muenchen (DE)

(72) Inventors: Michael SCHRAUT, Muenchen (DE); Markus STRASSBERGER, Wartenberg (DE)

(21) Appl. No.: 18/021,206

(22) PCT Filed: Aug. 11, 2021
(86) PCT No.: PCT/EP2021/072429

§ 371 Date: Feb. 14, 2023

(30) Foreign Application Priority Data
Sep. 15, 2020 (DE) 10 2020 124 050.3

(51) Int. Cl. G06Q 20/40; G06Q 20/38; G06Q 20/10

(52) U.S. Cl. CPC G06Q 20/40; G06Q 20/3827; G06Q 20/102; G06Q 2240/00

(57) ABSTRACT

A device for authenticating a first vehicle for a function is provided. The device is configured to determine an attribute codeword dependent on a vehicle attribute of the first vehicle and to compare the attribute codeword with a plurality of different reference codewords for a corresponding plurality of different vehicles. The device is further configured to determine, on the basis of the comparisons, whether or not the first vehicle is authenticated for the function.

### BACKGROUND AND SUMMARY OF THE INVENTION

The invention relates to a method and a corresponding device with which vehicle registration numbers can be securely evaluated, e.g. in order to authenticate and/or activate a vehicle for a defined function or service.

A vehicle can be unambiguously identified by way of its registration number. It therefore makes sense to facilitate the authentication of a vehicle for one or more functions and/or services by way of the registration number of the vehicle. It is problematic in this regard that storage and/or transmission of registration numbers can be problematic in terms of data protection law, particularly if vehicle users have not explicitly consented to the storage and/or transmission.

The present document is concerned with the technical object of facilitating a particularly secure authentication and/or activation of a vehicle for a function and/or service on the basis of a vehicle feature, in particular on the basis of a vehicle registration number.

The object is achieved by the claimed invention. It is pointed out that additional features of a patent claim dependent on an independent patent claim, without the features of the independent patent claim or only in combination with a subset of the features of the independent patent claim, can form an invention of their own that is independent of the combination of all features of the independent patent claim and can become the subject matter of an independent claim, a divisional application or a subsequent application. This applies in the same manner to technical teachings described in the description that can form an invention independent of the features of the independent patent claims.

According to one aspect, a device for authenticating a first (motor) vehicle for a function is described. Examples of functions are intake of an energy carrier (e.g. fuel or electric power) by the vehicle for driving the first vehicle; entering a restricted-entry region; and/or parking the first vehicle on a parking lot or in a parking garage.

The device is designed to ascertain (in particular to receive) a feature codeword dependent on at least one vehicle feature of the first vehicle. The vehicle feature can comprise, in particular can be, a registration number of the first vehicle. The feature codeword may have been ascertained by way of a cryptographic hash function, e.g. SHA-2. Furthermore, the feature codeword may have been encrypted by way of at least one predefined character string, in particular by way of at least one predefined salt. The feature codeword can thus indicate the vehicle feature in encrypted form.

The device can additionally be designed to compare the feature codeword to a plurality of different reference codewords for a corresponding plurality of different vehicles. The plurality of different vehicles can be the vehicles that are authenticated and/or activated for the function.

The device can be designed (prior to the checking of a feature codeword) to receive and store in a reference database the plurality of reference codewords from one or more different service providers for billing a fee for a function performed. The individual reference codewords can be received in conjunction with a certificate. The certificate for a reference codeword, for a vehicle and for a (payment) service provider can indicate that a check has taken place as to whether the service provider is authorized to pay a fee for a function performed for the owner of the vehicle.

In other words, the device can be designed to receive a certificate for a reference codeword from a specific service provider and for a specific vehicle. It can then be ascertained, on the basis of the certificate, whether the service provider is authorized to bill a fee for a function performed for the specific vehicle. The device can be designed to reject the reference codeword if it is ascertained that the service provider is not authorized to bill a fee for a function performed for the specific vehicle. Security can thus be further increased.

The different reference codewords may each have been ascertained on the basis of a vehicle feature of the vehicle in question. The individual reference codewords may have been ascertained by way of a cryptographic hash function, e.g. SHA-2. Furthermore, the individual reference codewords may have been encrypted by way of at least one predefined character string, in particular by way of at least one predefined salt. The individual reference codewords can thus each indicate at least one vehicle feature of a vehicle in encrypted form.

The plurality of reference codewords and the feature codeword may each have been ascertained on the basis of a uniform vehicle feature (of the respective vehicle) and/or on the basis of a uniform cryptographic hash function. In other words, the same cryptographic hash function may have been used for the different codewords. Furthermore, the same vehicle feature (e.g. the registration number of the respective vehicle in each case) may have been used for each of the different codewords.

The comparisons of the feature codeword with the different reference codewords thus make it possible to compare in an encrypted manner the vehicle feature of the first vehicle with the corresponding vehicle feature of the plurality of different vehicles.

The device is additionally designed to determine, on the basis of the comparisons, whether or not the first vehicle is authenticated for the function. In particular, the device can be designed to determine that the first vehicle is authenticated for the function if a reference codeword that corresponds to the feature codeword is identified from the plurality of reference codewords. Alternatively or additionally, the device can be designed to determine that the first vehicle is not authenticated for the function if no reference codeword that corresponds to the feature codeword is identified from the plurality of reference codewords.

The device thus enables a reliable and secure, in particular with respect to data protection regulations, authentication of or check on an authorization of a vehicle for a specific function.

The device can be designed so as, if it is determined that the first vehicle is authenticated for the function, to transmit a response to a (separate, spatially isolated) provider unit of a provider of the function in order to prompt provision of the function (e.g. to facilitate a fueling or charging process or to facilitate an access). Alternatively or additionally, the device can be designed so as, if it is determined that the first vehicle is authenticated for the function, to prompt a billing unit to transfer a fee for the provided function from a user of the first vehicle to the provider of the function. It is thus possible for the function to be provided and billed in a secure and reliable manner (in particular without considering the vehicle feature in clear text).

Alternatively or additionally, the device can be designed to transmit a response to a signaling unit (e.g. to a light element such as a lamp) if it is determined that the first vehicle is authenticated for the function, the signaling unit being designed to signal to the user of the first vehicle (e.g. by outputting a visual signal) that it has been determined that the first vehicle is authenticated for the function. Convenience for a user can thus be further increased.

The plurality of reference codewords can comprise multiple subgroups of reference codewords. The different subgroups can be associated with different providers of functions and/or with different billing units (e.g. with different payment service providers). The reference codewords of different subgroups may each have been encrypted with a different character string. On the other hand, the reference codewords of the same subgroup may have been encrypted with the same character string. The different providers and/or the different billing units can thus each be associated with a different character string (in particular a different salt).

The device can be designed to ascertain, on the basis of the comparisons, that a first reference codeword from the plurality of reference codewords corresponds to the first feature codeword. Furthermore, the device can be designed to ascertain, on the basis of the character string that was used for encrypting the first reference codeword, a provider unit of a provider of the function and/or a billing unit for billing a fee for the function performed. In this way, convenience and security when providing a function and/or when billing for a provided function can be further increased.

According to one aspect, a system for authenticating a first vehicle for a function is described. The system comprises a sensor unit (e.g. having a camera) which is designed to capture a vehicle feature (in particular a registration number) of the first vehicle. The sensor unit is additionally designed to ascertain a feature codeword on the basis of the vehicle feature. Furthermore, the system comprises an authentication device described in this document, which is designed to authenticate the first vehicle on the basis of the feature codeword.

The system can comprise at least one billing unit of a billing service provider. The billing unit can be designed to bill a fee for a function performed.

The sensor unit can be designed to receive from the billing service provider a predefined character string, in particular a predefined salt, for encrypting the vehicle feature of a vehicle and for ascertaining the feature codeword of the vehicle.

In particular, the sensor unit can receive different character strings from each of different billing service providers. A vehicle feature can then be encrypted with all available character strings in each case, with the result that multiple different feature codewords are ascertained for the multiple different billing service providers. These codewords can then be compared with the reference codewords by the authentication device. Thus a vehicle can be authenticated for a specific function in a reliable and secure manner. Furthermore, the billing service provider responsible for the billing can thus be identified in an efficient and secure manner.

The predefined character string of a payment service provider can be time-limited. Alternatively or additionally, the predefined character string can optionally have only spatially limited validity. Alternatively or additionally, the predefined character string can optionally only be valid for one or more specific functions. The security of the system can thus be further increased.

The system can comprise a plurality of different authentication devices for a corresponding plurality of respectively different reference codewords. The sensor unit can be designed to ascertain, on the basis of a property of the ascertained feature codeword (e.g. using a predefined allocation rule), to which of the plurality of different authentication devices the feature codeword is to be transmitted for authentication. The performance and the security of the system can thus be further increased.

According to a further aspect, a method for authenticating a first vehicle for a function is described. The method comprises ascertaining a feature codeword dependent on a vehicle feature of the first vehicle. The method additionally comprises comparing the feature codeword with a plurality of different reference codewords for a corresponding plurality of different vehicles. The method further comprises determining, on the basis of the comparisons, whether or not the first vehicle is authenticated for the function.

According to a further aspect, a software (SW) program is described. The SW program can be designed to be executed on a processor and to thereby carry out the method described in this document.

According to a further aspect, a storage medium is described. The storage medium can comprise an SW program that is designed to be executed on a processor and to thereby carry out the method described in this document.

It should be noted that the methods, devices and systems described in this document can be used both alone and in combination with other methods, devices and systems described in this document. Furthermore, all aspects of the methods, devices and systems described in this document can be combined with one another in multiple manners. In particular, the features of the claims can be combined with one another in multiple manners.

The invention will be described in detail below with reference to exemplary embodiments.

### BRIEF DESCRIPTION OF THE DRAWINGS

FIG. 1 shows an example of a system for evaluating a vehicle feature.

FIG. 2 shows an example of a codeword database.

FIG. 3 shows a flowchart for an example of a method for evaluating a vehicle feature.

### DETAILED DESCRIPTION OF THE DRAWINGS

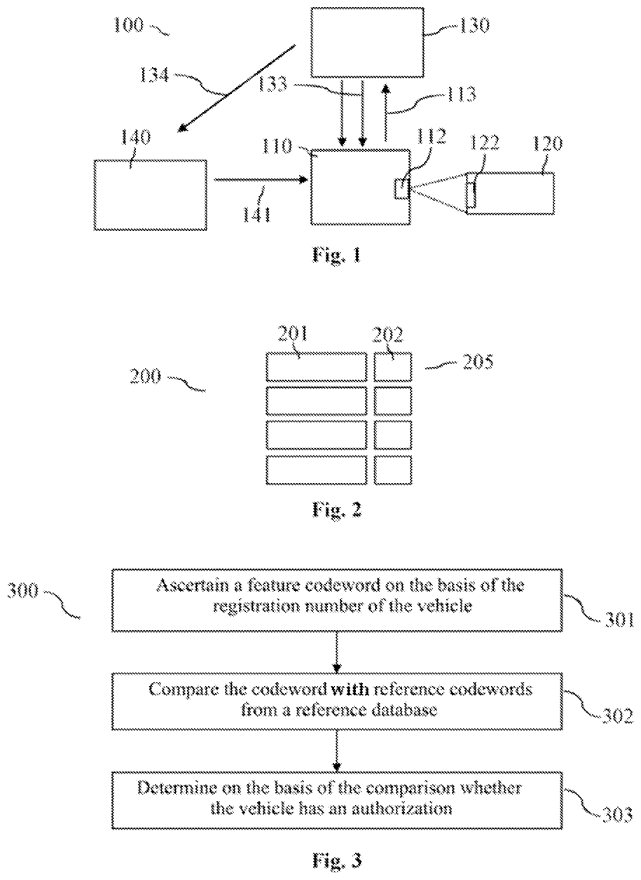

As set forth in the introduction, the present document is concerned with the secure, in particular with respect to data protection regulations, authentication and/or activation of a (motor) vehicle (e.g. a passenger vehicle, a truck, a bus and/or a motorcycle) for a service and/or for a function. In this context, FIG. 1 shows an example of a system 100 that comprises a provider unit 110 that is operated by a provider of a function and/or a service. Examples of functions and/or services are, for example, fueling an energy store of a vehicle 120, accessing a drive-in cinema, accessing a specific street, etc.

The provider unit 110 can be designed to capture, by way of a sensor or by way of a sensor unit 112, in particular by way of a camera, sensor data, in particular image data, relating to a vehicle feature 122, in particular relating to the registration number, of the vehicle 120. The provider unit 110 and/or the sensor unit 112 can additionally be designed to encrypt the vehicle feature 122 in order to ascertain a feature codeword 113. A cryptographic hash function (such as SHA-2) can be used for this purpose. The vehicle feature 122 can be encrypted together with one or more salts in order to further increase data security.

The feature codeword 113 can be transmitted to a separate checking unit 130 (for example to a so-called broker). The checking unit 130 is also referred to in general in this document as a device. The checking unit 130 can be designed to compare the feature codeword 113 with reference codewords 201 from a reference database 200 (see FIG. 2). The reference database 200 can comprise a plurality of reference data records 205 for a corresponding plurality of different vehicles 120.

A reference data record 205 for a specific vehicle 120 can comprise a reference codeword 201 for the specific vehicle 120. The reference codeword 201 has been ascertained, in particular encrypted in this case, in the same manner as the feature codeword 113 for the specific vehicle 120, i.e. on the basis of the same vehicle feature 112, on the basis of the same cryptographic hash function and/or on the basis of the same one or more salts.

In addition, the reference data record 205 for the specific vehicle 120 can comprise function information 202. An example of function information 202 is
information relating to the one or more functions and/or services for which the specific vehicle 120 is authorized; and/or
information relating to a billing method, e.g. relating to a billing service provider, for billing a fee for a service that has been used.

The checking unit 130 can be designed to compare the feature codeword 113 provided by the provider unit 110 with one or more reference codewords 201 from the reference database 200. In particular, the checking unit 130 can be designed to check whether or not the feature codeword 113 matches one of the reference codewords 201 from the reference database 200. The checking unit 130 can then give a response 133 to the provider unit 110 on the basis of the check. In particular, an approval for the function and/or the service can be issued as the response 133 if a match between the feature codeword 113 and a reference codeword 201 has been found. Furthermore, function information 202 from the reference data record 201 for the identified reference codeword 201 can optionally be reported back. On the other hand, a denial can be provided as the response 133 if no match between the feature codeword 113 and any reference codeword 201 from the reference database 200 has been able to be found.

The checking unit 130 can additionally be designed to transmit billing data 134 to a billing unit 140. The billing data 134 can indicate, for example, an amount of money which the vehicle 120 or the user of the vehicle 120 must pay for the function and/or service performed by the provider. The billing unit 140 can be operated by a bank or a payment service provider, for example. Billing can thus be initiated directly by the checking unit 130. The billing unit 140 can then send the provider unit 110 a confirmation 141 that the billing for the performed function and/or service has been performed. This communication can be accomplished without this requiring the vehicle feature 122 to be communicated in clear text.

The system 100 thus facilitates authentication and/or activation of a vehicle 120 for a function and/or service without this requiring explicit storage and/or evaluation of a vehicle feature 122, in particular a registration number.

Thus a method is described in which a vehicle registration number 122 for example (and/or a different vehicle feature) is read in and encrypted with one or more salts if applicable. The one or more salts can be directly stored in a memory (e.g. a read-only memory) on the scanning system 112 (e.g. a camera). This can be done for example by an operator of the checking unit 130 and/or by an operator of the provider unit 110 and/or by an operator of the billing unit 140.

Furthermore, the encrypted version of the registration number+salt can be stored as the reference codeword 201 in a reference database 200. This can be done for all users of the system 100, in particular for all vehicles 120 that use the system 100. The reference database 200 can be stored on an independent broker system, i.e. on the checking unit 130, which broker system can carry out comparisons of hash values, i.e. codewords 113, 201, and thus bring together the provider of a function and/or service and the scanning system 112.

The method can have the following steps: a scanner 112 scans a registration number 122 and encrypts it with all one or more stored salts and transmits the one or more hash values 113 to the independent broker 130. The broker 130 compares the one or more hash values 113 with all reference hash values 201 that have been stored by the respective provider of the function and/or service. If a match is found, then the broker 130 issues an authorization and connects additional systems for subsequent communication if appropriate. If no match can be found, then it can be stated that the registration number 122 is not registered with a provider. The registration number 122 has not been sent and/or compared in clear text in the process, however.

In one example, a vehicle 120 drives up to a fuel dispenser, for example. The registration number 122 is scanned and the hash value 113 is transmitted to the broker 130. After a positive check, the broker 130 reports that the hash value 113 has a fueling authorization. The fuel dispenser is then activated. Furthermore, the broker 130 can connect the payment service provider 140 to the fuel dispenser for automatic billing. This method can be used in a similar manner for an entry authorization and/or for a parking service.

Prior to the operation of the described system 100, different operators or service providers of different billing units 140 (e.g. different service providers for billing for a specific function) can each provide different operator-specific character strings, in particular salts, in the broker 130 and/or in the scanner 112. Furthermore, the individual operators or service providers can provide the broker 130 with the registration numbers 122, encrypted with the respective operator-specific character string, of the respective operator's customers as reference codewords 201.

The scanner 112 can then encrypt a captured registration number 122 with each individual one of the plurality of character strings in each case, in order to ascertain a corresponding plurality of feature codewords 113. The plurality of feature codewords 113 can then be transmitted to the broker 130 and the broker 130 can use comparison with the reference codewords 201 to determine whether the captured registration number 122 is registered with an operator or service provider, and with which operator or service provider the captured registration number 122 is registered.

A (payment) service provider (e.g. a fueling biller) can thus transmit its salt via the broker 130 to the individual scanners 112 (cameras), which use it to encrypt registration numbers 122 and transmit them to the broker 130. There is at least one separate salt for each payment service provider. The payment service provider simultaneously stores its customer data in the form of hash values (customer registration number+salt), i.e. as reference codewords 201, with the broker. The scanners 112 do not compare on their own, but rather transmit the N hash values 113 (for the N payment service providers) to the broker 130, which then compares them with the reference codewords 201. If there is a match, the payment service provider is ascertained on the basis of the payment service provider's salt. Data relating to the operator of the function (e.g. the filling station) and/or relating to the amount to be paid can then be forwarded to the payment service provider. The payment can be made on the basis of known online payment methods.

To further increase security, the salts (and consequently the hash values ascertained therewith) can be time-limited. After a predefined period of time has elapsed, a payment service provider can therefore provide the broker 130 with one or more new salts and with reference codewords 201 encrypted with the one or more new salts. The expired salts and the reference codewords 201 can then be deleted.

Alternatively or additionally, the salts and/or the reference codewords 201 can have a spatial validity (and be valid only for a specific region in each case). The performance of a scanner 112 and/or a broker 130 can be increased in this manner.

Alternatively or additionally, the individual salts can have a semantic limitation relating to individual functions or function groups. For example, a salt can optionally be valid only for a fueling function or only for a parking function. The number of hash values 113 that a scanner 112 must calculate can be reduced in this way. The efficiency of the system 100 can thus be increased.

For load distribution and/or to further increase security, the hash values 201 of a (payment) provider or service provider x can be distributed to a number y>1 of brokers 130, in particular in such a manner that only some of the known hash values 201 are stored on each of these brokers 130. The algorithm for the distribution can be based on the resulting hash value 201 and is known to the service provider and/or the scanner 112. In particular, a standardized method can be used for distributing the hash values 201. For example, all even-numbered hash values 201 can be stored on a broker A and all odd-numbered hash values 201 can be stored on a broker B. If applicable, further mirroring can be performed for performance reasons, for example to ensure a fast response time. For example, brokers A & B (even-numbered hash values 201) and brokers C & D (odd-numbered hash values 201) can each have the same data records 205. All even-numbered hash values 201 can then be transmitted by the scanner 112 to brokers A and B of the service provider. All odd-numbered hash values 201 can be transmitted to brokers C and D, which means that if one broker is overloaded, a fast response by the other broker can still be expected. This applies to any other distribution algorithms analogously.

The system 100 can have an interface for signaling a successful and/or an unsuccessful match. For example, the system 100 can be designed to detect whether a vehicle 120 is authorized to park on a specific parking lot (e.g. because the vehicle owner and the parking lot owner have an appropriate agreement). The broker 130 recognizes a match and signals it to the service provider. If the service provider agrees, a further display device can be informed, for example a lamp at the applicable parking lot which lights up green in the event of a successful match (and otherwise does not). This allows immediate feedback as to whether the system 100 has correctly detected the vehicle.

The function of the broker 130 can optionally be integrated in the scanner 112. The scanner 112 then needs to have an appropriate level of computing performance. Furthermore, this impairs only some of the security with respect to data protection.

The system 100 can be designed such that a certification system is used to ensure or needs to be used to verify that the service provider has a contractual agreement with the owner of a vehicle 120. For example, a certified identity manager can confirm that John Doe (represented in the system 100 with the user name j.doe for example) is the currently legitimate owner of the vehicle 120 with registration number 122 X-YZ 1234. On the basis of this confirmation, the service provider can then request an electronic certificate from a governmental or independent institution (for example the licensing authority) showing that the registration number X-YZ 1234 and the identity of the vehicle owner Mr. Doe match. The certificate thus states that the service provider has a valid contractual relationship with the owner for the registration number X-YZ 1234. On this basis, an additional independent instance can calculate the hash value (i.e. the reference codeword 201) using the salt of the service provider and the registration number of the vehicle 120. A certificate of the entire legality of the data comparison can be included. The hash value 201 and the certificate are made available to the broker 130. The broker 130 can optionally accept the request only if the certificate is valid. Data security can thus be further increased.

FIG. 3 shows a flowchart for an example of a method 300 (optionally computer-implemented) for authenticating a first vehicle 120 for a function (e.g. for a fueling or charging procedure). The method 300 comprises ascertaining 301 a feature codeword 113 dependent on a vehicle feature 122 of the first vehicle 120. The feature codeword 113 can comprise a hash value or be a hash value that has been ascertained on the basis of the vehicle feature 122 by using a cryptographic hash function. The feature codeword 113 can be ascertained by a sensor unit 112 and/or by a provider unit 110 of the provider of the function and can be transmitted, for example, to a checking unit or to a broker 130.

The method 300 further comprises comparing 302 the feature codeword 113 with a plurality of different reference codewords 201 for a corresponding plurality of different vehicles 120. The reference codewords 201 may have been ascertained in advance and stored on a storage unit (of the checking unit 130).

The method 300 further comprises determining 303, on the basis of the comparisons, whether or not the first vehicle 120 is authenticated for the function. Thus authentication of vehicles can be facilitated in a reliable and secure manner, in particular with respect to data protection.

The present invention is not limited to the exemplary embodiments shown. It should be noted in particular that the description and the figures are only intended to illustrate the principle of the proposed methods, devices and systems by way of example.

1.-15. (canceled)

16. A device for authenticating a first vehicle for a function, wherein the device is configured:
to ascertain a feature codeword dependent on a vehicle feature of the first vehicle;
to compare the feature codeword with a plurality of different reference codewords for a corresponding plurality of different vehicles; and
to determine, based on the comparisons, whether or not the first vehicle is authenticated for the function.

17. The device according to claim 16, wherein the device is further configured, upon determining that the first vehicle is authenticated for the function:
to transmit a response to a provider unit of a provider of the function in order to prompt provision of the function; and/or
to transmit a response to a signaling unit, wherein the signaling unit is configured to signal to a user of the first vehicle that it has been determined that the first vehicle is authenticated for the function; and/or
to prompt a billing unit to transfer a fee for the provided function from a user of the first vehicle to the provider of the function.

18. The device according to claim 16, wherein the plurality of reference codewords and the feature codeword have each been ascertained:
based on a uniform vehicle feature; and/or
based on a uniform cryptographic hash function.

19. The device according to claim 16, wherein the plurality of reference codewords and the feature codeword have been encrypted by way of at least one predefined character string.

20. The device according to claim 19, wherein the plurality of reference codewords and the feature codeword have been encrypted by way of at least one predefined salt.

21. The device according to claim 16, wherein the device is further configured:
to determine that the first vehicle is authenticated for the function if a reference codeword that corresponds to the feature codeword is identified from the plurality of reference codewords; and/or
to determine that the first vehicle is not authenticated for the function if no reference codeword that corresponds to the feature codeword is identified from the plurality of reference codewords.

22. The device according to claim 16, wherein:
the plurality of reference codewords comprises multiple subgroups of reference codewords;
the reference codewords of different subgroups have each been encrypted with a different character string;
the reference codewords of the same subgroup have been encrypted with the same character string; and
the device is further configured:
to ascertain, based on the comparisons, that a first reference codeword from the plurality of reference codewords corresponds to a first feature codeword; and
to ascertain, based on the character string that was used for encrypting the first reference codeword, a provider unit of a provider of the function and/or a billing unit for billing a fee for the function performed.

23. The device according to claim 16, wherein the device is further configured to receive and store in a reference database the plurality of reference codewords from one or more different service providers in order to bill a fee for the function performed.

24. The device according to claim 23, wherein the device is further configured:
to receive a certificate for a reference codeword from a specific service provider and for a specific vehicle;
to check, based on the certificate, whether the service provider is authorized to bill a fee for a function provided for the specific vehicle; and
to reject the reference codeword upon ascertaining that the service provider is not authorized to bill the fee for the function performed for the specific vehicle.

25. The device according to claim 16, wherein the vehicle feature comprises a registration number of the first vehicle.

26. The device according to claim 16, wherein the vehicle feature is a registration number of the first vehicle.

27. The device according to claim 16, wherein the function comprises:
taking in an energy carrier for driving the first vehicle;
entering a restricted-entry region; and/or
parking the first vehicle on a parking lot or in a parking garage.

28. A system for authenticating a first vehicle for a function, the system comprising:
a sensor unit that is configured:
to capture a vehicle feature of the first vehicle; and
to ascertain a feature codeword based on the vehicle feature; and
the device according to claim 16, wherein the device is configured to authenticate the first vehicle based on the feature codeword.

29. The system according to claim 28, wherein:
the system further comprises at least one billing unit of a billing service provider; and
the sensor unit is configured to receive from the billing service provider a predefined character string for encrypting the vehicle feature of a vehicle and for ascertaining the feature codeword of the vehicle.

30. The system according to claim 28, wherein:
the system further comprises at least one billing unit of a billing service provider; and
the sensor unit is configured to receive from the billing service provider a predefined salt for encrypting the vehicle feature of a vehicle and for ascertaining the feature codeword of the vehicle.

31. The system according to claim 29, wherein:
the predefined character string is time-limited; and/or
the predefined character string has only spatially limited validity; and/or
the predefined character string is only valid for one or more specific functions.

32. The system according to claim 28, wherein:
the system further comprises a plurality of different authentication devices for a corresponding plurality of respectively different reference codewords; and
the sensor unit is configured to ascertain, based on a property of the ascertained feature codeword, to which of the plurality of different authentication devices the feature codeword is to be transmitted for authentication.

33. A method for authenticating a first vehicle for a function, the method comprising:
ascertaining a feature codeword dependent on a vehicle feature of the first vehicle;
comparing the feature codeword with a plurality of different reference codewords for a corresponding plurality of different vehicles; and
determining, based on of the comparisons, whether or not the first vehicle is authenticated for the function.
